(19) United States
(12) Patent Application Publication
(10) Pub. No.: US 2022/0007628 A1
(43) Pub. Date: Jan. 13, 2022

(54) FISHING STORAGE BOX ASSEMBLY

(71) Applicant: Charley Brown, San Diego, CA (US)

(72) Inventor: Charley Brown, San Diego, CA (US)

(21) Appl. No.: 16/924,312

(22) Filed: Jul. 9, 2020

(51) Int. Cl. A01K 97/06

(52) U.S. Cl. CPC A01K 97/06

(57) ABSTRACT

A fishing storage box assembly for includes a box that has a plurality of drawer slots each being integrated therein. A lid is hingedly coupled to the box for opening and closing the box. A pair of first cup holders and a pair of second cup holders is provided to hold a beverage container. A plurality of drawers is each slidably positioned in a respective one of the drawer slots in the box to store fishing tackle. A plurality of rollers is each rotatably coupled to the box to roll along a support surface to facilitate the box to be transported on the support surface. A bottle opener is coupled to the lid to remove a cap from a bottle and a closure is movably coupled to the box for retaining the lid in a closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage box devices and more particularly pertains to a new storage box device for storing fishing tackle, a fishing rod and food items in a single device.

### (2) Description of Related Art Including Information Disclosed Under 37 CFR 1.97 and 1.98

The prior art relates to storage box devices including a cooler that has a removable lid which has a bait storage compartment integrated into the lid. The prior art discloses a tackle box that has a rigid cutting board for a lid. The prior art also discloses a tackle box that has a pair of loops for holding a fishing rod. The prior art discloses a cooler that includes storage for fishing tackle and a plurality of fishing rods. The prior art discloses a modular cooler for containing fishing tackle and food items. The prior art further discloses a variety of devices combining tackle boxes and portable coolers.

### BRIEF SUMMARY OF THE INVENTION

An embodiment of the disclosure meets the needs presented above by generally comprising a box has a plurality of drawer slots each is integrated therein. A lid is hingedly coupled to the box for opening and closing the box. A pair of first cup holders and a pair of second cup holders is provided to hold a beverage container. A plurality of drawers is each slidably positioned in a respective one of the drawer slots in the box to store fishing tackle. A plurality of rollers is each rotatably coupled to the box to roll along a support surface to facilitate the box to be transported on the support surface. A bottle opener is coupled to the lid to remove a cap from a bottle and a closure is movably coupled to the box for retaining the lid in a closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a fishing storage box assembly according to an embodiment of the disclosure.

FIG. 2 is a front perspective view of an embodiment of the disclosure.

FIG. 3 is a left side phantom view of an embodiment of the disclosure.

FIG. 4 is a cross sectional view taken along line 4-4 of FIG. 1 of an embodiment of the disclosure.

FIG. 5 is a front view of an embodiment of the disclosure.

### DETAILED DESCRIPTION OF THE INVENTION

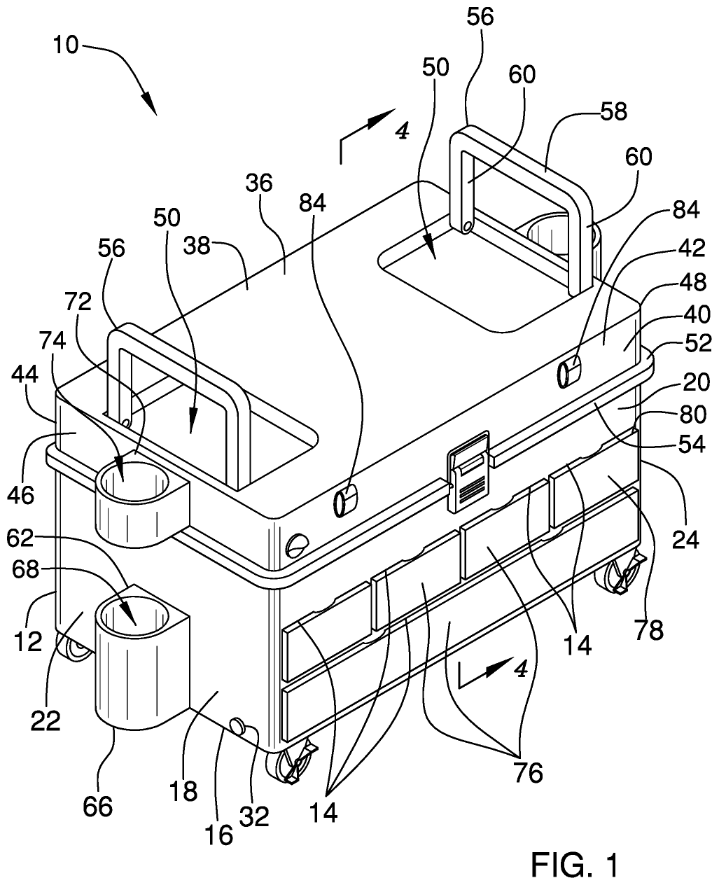

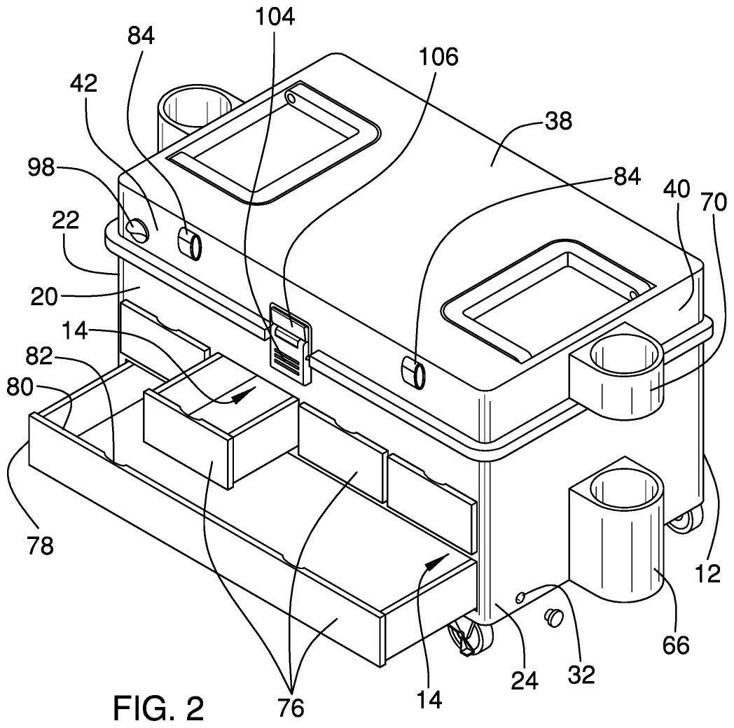

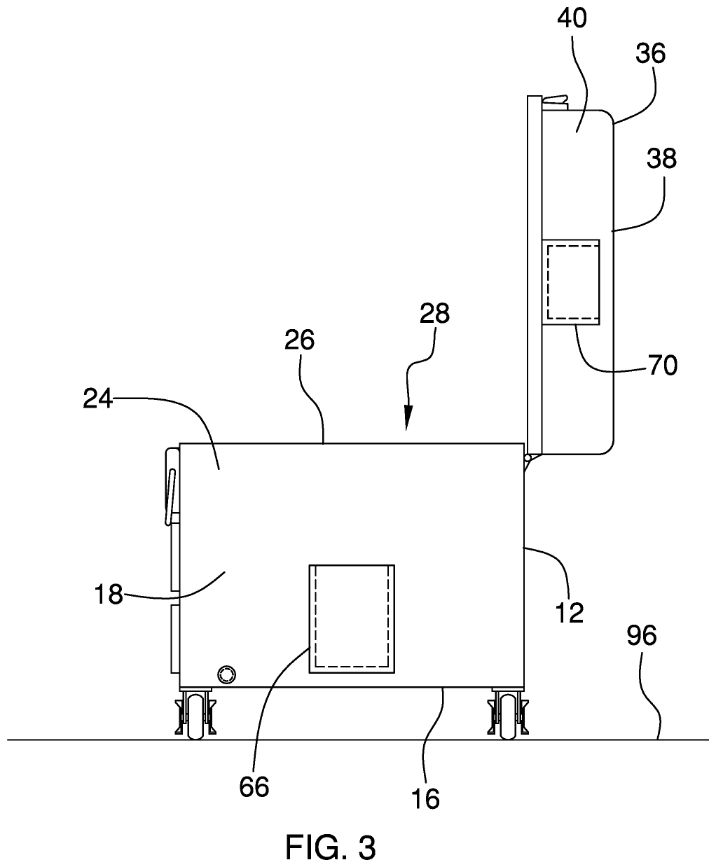

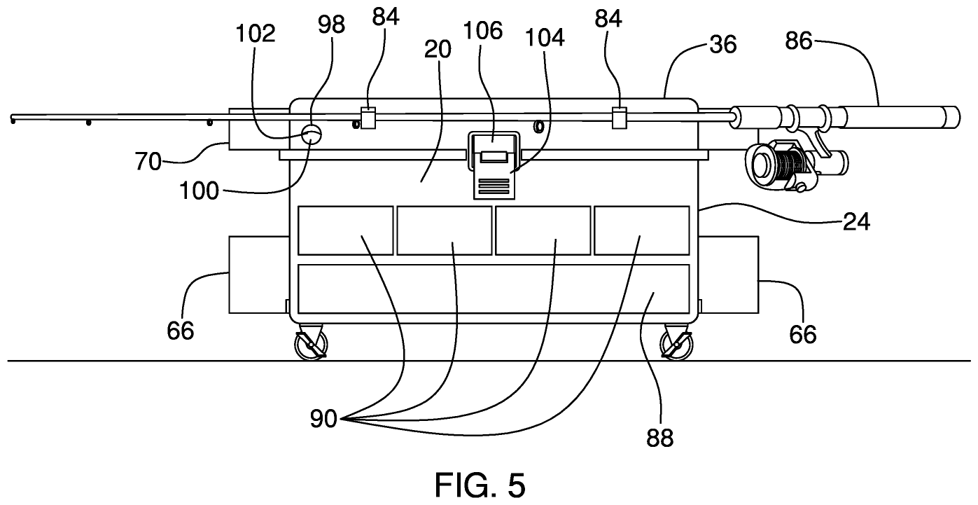

With reference now to the drawings, and in particular to FIGS. 1 through 5 thereof, a new storage box device embodying the principles and concepts of an embodiment of the disclosure and generally designated by the reference numeral 10 will be described.

As best illustrated in FIGS. 1 through 5, the fishing storage box assembly 10 generally comprises a box 12 that has a plurality of drawer slots 14 each being integrated therein. The box 12 has a bottom wall 16 and an outer wall 18 extending upwardly therefrom, and the outer wall 18 has a front side 20, a first lateral side 22 and a second lateral side 24. Each of the drawer slots 14 extends into the front side 20 of the outer wall 18. The outer wall 18 has a distal edge 26 with respect to the bottom wall 16 to define an opening 28 into the box 12. The outer wall 18 has a lip 30 extending outwardly therefrom. The lip 30 is aligned with the distal edge 26 and the lip 30 extends around the first lateral side 22, the front side 20 and the second lateral side 24 of the outer wall 18. The box 12 may be comprised of a thermally insulating material thereby facilitating the box 12 to function as a cooler for storing ice and food items. A pair of drains 32 may extend through the outer wall 18 of the box 12 for draining water from the box 12 and a pair of plugs 34 may each be removably inserted into a respective drain 32 for closing the respective drain 32.

A lid 36 is hingedly coupled to the box 12 for opening and closing the box 12. The lid 36 has a top wall 38 and a perimeter wall 40 extending downwardly therefrom, and the perimeter wall 40 has a front side 42, a back side 44, a first lateral side 46 and a second lateral side 48. The top wall 38 has a pair of wells 50 each extending downwardly therein and each of the wells 50 is positioned adjacent to a respective one of the first lateral side 46 and the second lateral side 48 of the perimeter wall 40. The perimeter wall 40 has a lip 52 extending outwardly therefrom and the lip 52 on the perimeter wall 40 is aligned with a bottom threshold of the perimeter wall 40. The lip 52 on the perimeter wall 40 extends around the first lateral side 22, the front side 20 and the second lateral side 24 of the perimeter wall 40. The lip 52 on the perimeter wall 40 has a foot 54 extending downwardly therefrom and the foot 54 is spaced from the perimeter wall 40. The lip 52 on the perimeter wall 40 rests on the lip 30 on the outer wall 18 of the box 12 when the lid 36 is closed and the foot 54 extends downwardly in front of the lip 30 on the outer wall 18 of the box 12 when the lid 36 is closed.

A pair of handles 56 is each pivotally coupled to the lid 36 for carrying the box 12 and the lid 36 when the lid 36 is closed. Each of the handles 56 comprises a central member 58 extending between a pair of outward members 60. Each of the outward members 60 has a distal end 62 with respect to the central member 58 and the distal end 62 of each of the outward members 60 is pivotally coupled to a bounding surface 64 of a respective one of the wells 50 in the top wall 38 of the lid 36. Each of the handles 56 is positionable in a stored position having each of the handles 56 resting in the respective well 50 in the lid 36. Conversely, each of the handles 56 is positionable in a deployed position has each of the handles 56 extending upwardly from the respective well 50.

A pair of first cup holders 66 is each coupled to the box 12 to hold a beverage container, such as a bottle or a can. Each of first cup holders 66 is coupled to a respective one of the first lateral side 22 and the second lateral side 24 of the outer wall 18 of the box 12, and each of the first cup holders 66 has an upper side 67. The upper side 67 of each of the first cup holders 66 has a well 68 extending downwardly therein for insertably receiving the beverage container.

A pair of second cup holders 70 is each coupled to the lid 36 to hold a beverage container, such as a bottle or a can. Each of the second cup holders 70 is positioned on a respective one of the first lateral side 22 and the second lateral side 24 of the perimeter wall 40 of the lid 36, and each of the second cup holders 70 has a top side 72. The top side 72 of each of the second cup holders 70 has a well 74 extending downwardly therein to insertably receive the beverage container.

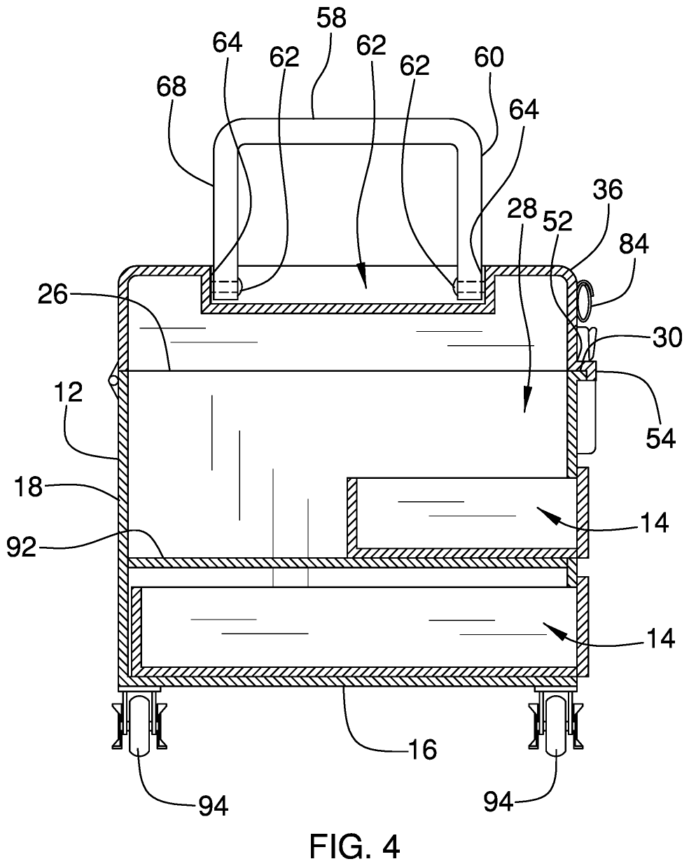

A plurality of drawers 76 is slidably positioned in a respective one of the drawer slots 14 in the box 12 to store fishing tackle. Each of the drawers 76 has a front face 78 and the front face 78 on each of the drawers 76 has an upper edge 80. The upper edge 80 of the front face 78 of each of the drawers 76 has a cut out 82 therein to facilitate a user to grip the front face 78 when the drawers 76 are closed for opening the drawers 76. A pair of loops 84 is provided and each of the loops 84 is coupled to the lid 36. A fishing pole 86 is extendable through each of the loops 84 to facilitate the fishing pole 86 to be transported with the box 12. Additionally, each of the loops 84 is positioned on the front side 20 of the perimeter wall 40 of the lid 36. The plurality of drawers 76 may include a first drawer 88 and a set of second drawers 90 that are positioned above the first drawer 88. Each of the set of second drawers 90 may have a width that is less than the width of the first drawer 88. As is most clearly shown in FIG. 4, a divider 92 may be positioned within the box 12 that extends between the first drawer 88 and the second set of drawers 90.

A plurality of rollers 94 is provided and each of the rollers 94 is rotatably coupled to the box 12 to roll along a support surface 96 thereby facilitating the box 12 to be transported on the support surface 96. Each of the rollers 94 is positioned on the bottom wall 16 of the box 12 and each of the rollers 94 is aligned with a respective one of four corners of the bottom wall 16. A bottle opener 98 is coupled to the lid 36 to remove a cap from a bottle. The bottle opener 98 has an opening 100 extending therein and a ridge 102 extending across the opening 100. The opening 100 insertably receives the cap and the ridge 102 pries the cap from the bottle. The bottle opener 98 is positioned on the front side 20 of the perimeter wall 40 of the lid 36.

A closure 104 is movably coupled to the box 12 and the closure 104 releasably engages the lid 36 for retaining the lid 36 in a closed position. The closure 104 is positioned on the front side 20 of the outer wall 18 of the box 12. The closure 104 engages an engagement point 106 on the front side 20 of the perimeter wall 40 of the lid 36 when the closure 104 is positioned in a closed position. Conversely, the closure 104 disengages the engagement point 106 when the closure 104 is positioned in an opened position.

In use, fishing tackle is positioned in selected drawers 76 for storage, the fishing pole 86 is extended through the loops 84, and food items and beverages can be stored in the box 12. In this way the fishing tackle, the fishing pole 86 and the food items can be easily transported together. Each of the first cup holders 66 and the second cup holders 70 can hold a beverage container, and the bottle opener 98 can be employed to open bottles. Moreover, the handles 56 can be positioned in the deployed position to facilitate the box 12 and the lid 36 to be carried.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing storage box assembly for storing fishing tackle, a fishing rod and beverage containers, said assembly comprising:
a box having a plurality of drawer slots each being integrated therein;
a lid being hingedly coupled to said box for opening and closing said box;
a pair of handles, each of said handles being pivotally coupled to said lid for carrying said box and said lid when said lid is closed;
a pair of first cup holders, each of said first cup holders being coupled to said box wherein each of said first cup holders is configured to hold a beverage container;
a pair of second cup holders, each of said second cup holders being coupled to said lid wherein each of said second cup holders is configured to hold a beverage container;
a plurality of drawers, each of said drawers being slidably positioned in a respective one of said drawer slots in said box wherein each of said drawers is configured to store fishing tackle;
a pair of loops, each of said loops being coupled to said lid, each of said loops having a fishing pole being extendable therethrough wherein each of said loops is configured to facilitate the fishing pole to be transported with said box;
a plurality of rollers, each of said rollers being rotatably coupled to said box wherein each of said rollers is configured to roll along a support surface to facilitate said box to be transported on the support surface;
a bottle opener being coupled to said lid wherein said bottle opener is configured to remove a cap from a bottle; and
a closure being movably coupled to said box, said closure releasably engaging said lid for retaining said lid in a closed position.

2. The assembly according to claim 1, wherein said box has a bottom wall and an outer wall extending upwardly therefrom, said outer wall having a front side, a first lateral side and a second lateral side, each of said drawer slots extending into said front side of said outer wall, said outer wall having a distal edge with respect to said bottom wall to define an opening into said box.

3. The assembly according to claim 2, wherein said outer wall has a lip extending outwardly therefrom, said lip being aligned with said distal edge, said lip extending around said first lateral side, said front side and said second lateral side of said outer wall.

4. The assembly according to claim 3, wherein:
said lid has a top wall and a perimeter wall extending downwardly therefrom, said perimeter wall having a front side, a back side, a first lateral side and a second lateral side;
said top wall has a pair of wells each extending downwardly therein, each of said wells being positioned adjacent to a respective one of said first lateral side and said second lateral side of said perimeter wall; and
said perimeter wall has a lip extending outwardly therefrom, said lip on said perimeter wall being aligned with a bottom threshold of said perimeter wall, said lip on said perimeter wall extending around said first lateral side, said front side and said second lateral side of said perimeter wall, said lip on said perimeter wall having a foot extending downwardly therefrom, said foot being spaced from said perimeter wall, said lip on said perimeter wall resting on said lip on said outer wall of said box when said lid is closed, said foot extending downwardly in front of said lip on said outer wall of said box when said lid is closed.

5. The assembly according to claim 4, wherein each of said handles comprises a central member extending between a pair of outward members, each of said outward members having a distal end with respect to said central member, said distal end of each of said outward members being pivotally coupled to a bounding surface of a respective one of said wells in said top wall of said lid, each of said handles being positionable in a stored position having each of said handles resting in said respective well, each of said handles being positionable in a deployed position having each of said handles extending upwardly from said respective well.

6. The assembly according to claim 2, wherein each of first cup holders is coupled to a respective one of said first lateral side and said second lateral side of said outer wall of said box, each of said first cup holders having an upper side, said upper side of each of said first cup holders having a well extending downwardly therein for insertably receiving the beverage holder.

7. The assembly according to claim 3, wherein each of said second cup holders is positioned on a respective one of said first lateral side and said second lateral side of said perimeter wall of said lid, each of said second cup holders having a top side, said top side of each of said second cup holders having a well extending downwardly therein wherein said well in each of said second cup holders is configured to insertably receive the beverage container.

8. The assembly according to claim 1, wherein each of said drawers has a front face, said front face on each of said drawers having an upper edge, said upper edge of said front face of each of said drawers having a cut out therein wherein said cut out is configured to facilitate a user to grip said front face when said drawers are closed for opening said drawers.

9. The assembly according to claim 4, wherein said closure is positioned on said front side of said outer wall of said box, said closure engaging an engagement point on said front side of said perimeter wall of said lid when said closure is positioned in a closed position, said closure disengaging said engagement point when said closure is positioned in an opened position.

10. A fishing storage box assembly for storing fishing tackle, a fishing rod and beverage containers, said assembly comprising:
a box having a plurality of drawer slots each being integrated therein, said box having a bottom wall and an outer wall extending upwardly therefrom, said outer wall having a front side, a first lateral side and a second lateral side, each of said drawer slots extending into said front side of said outer wall, said outer wall having a distal edge with respect to said bottom wall to define an opening into said box, said outer wall having a lip extending outwardly therefrom, said lip being aligned with said distal edge, said lip extending around said first lateral side, said front side and said second lateral side of said outer wall;
a lid being hingedly coupled to said box for opening and closing said box, said lid having a top wall and a perimeter wall extending downwardly therefrom, said perimeter wall having a front side, a back side, a first lateral side and a second lateral side, said top wall having a pair of wells each extending downwardly therein, each of said wells being positioned adjacent to a respective one of said first lateral side and said second lateral side of said perimeter wall, said perimeter wall having a lip extending outwardly therefrom, said lip on said perimeter wall being aligned with a bottom threshold of said perimeter wall, said lip on said perimeter wall extending around said first lateral side, said front side and said second lateral side of said perimeter wall, said lip on said perimeter wall having a foot extending downwardly therefrom, said foot being spaced from said perimeter wall, said lip on said perimeter wall resting on said lip on said outer wall of said box when said lid is closed, said foot extending downwardly in front of said lip on said outer wall of said box when said lid is closed;
a pair of handles, each of said handles being pivotally coupled to said lid for carrying said box and said lid when said lid is closed, each of said handles comprising a central member extending between a pair of outward members, each of said outward members having a distal end with respect to said central member, said distal end of each of said outward members being pivotally coupled to a bounding surface of a respective one of said wells in said top wall of said lid, each of said handles being positionable in a stored position having each of said handles resting in said respective well, each of said handles being positionable in a deployed position having each of said handles extending upwardly from said respective well;
a pair of first cup holders, each of said first cup holders being coupled to said box wherein each of said first cup holders is configured to hold a beverage container, each of first cup holders being coupled to a respective one of said first lateral side and said second lateral side of said outer wall of said box, each of said first cup holders having an upper side, said upper side of each of said first cup holders having a well extending downwardly therein for insertably receiving the beverage holder;
a pair of second cup holders, each of said second cup holders being coupled to said lid wherein each of said second cup holders is configured to hold a beverage container, each of said second cup holders being positioned on a respective one of said first lateral side and said second lateral side of said perimeter wall of said lid, each of said second cup holders having a top side, said top side of each of said second cup holders having a well extending downwardly therein wherein said well in each of said second cup holders is configured to insertably receive the beverage container;
a plurality of drawers, each of said drawers being slidably positioned in a respective one of said drawer slots in said box wherein each of said drawers is configured to store fishing tackle, each of said drawers having a front face, said front face on each of said drawers having an upper edge, said upper edge of said front face of each of said drawers having a cut out therein wherein said cut out is configured to facilitate a user to grip said front face when said drawers are closed for opening said drawers;
a pair of loops, each of said loops being coupled to said lid, each of said loops having a fishing pole being extendable therethrough wherein each of said loops is configured to facilitate the fishing pole to be transported with said box, each of said loops being positioned on said front side of said perimeter wall of said lid;
a plurality of rollers, each of said rollers being rotatably coupled to said box wherein each of said rollers is configured to roll along a support surface to facilitate said box to be transported on the support surface, each of said rollers being positioned on said bottom wall of said box, each of said rollers being aligned with a respective one of four corners of said bottom wall;
a bottle opener being coupled to said lid wherein said bottle opener is configured to remove a cap from a bottle, said bottle opener having an opening extending therein and a ridge extending across said opening wherein said opening is configured to have the cap positioned therein and said ridge is configured to pry the cap from the bottle, said bottle opener being positioned on said front side of said perimeter wall of said lid; and
a closure being movably coupled to said box, said closure releasably engaging said lid for retaining said lid in a closed position, said closure being positioned on said front side of said outer wall of said box, said closure engaging an engagement point on said front side of said perimeter wall of said lid when said closure is positioned in a closed position, said closure disengaging said engagement point when said closure is positioned in an opened position.
